(19) United States
(12) Patent Application Publication
(10) Pub. No.: US 2004/0134946 A1
(43) Pub. Date: Jul. 15, 2004

(54) Vehicle seat cargo storage apparatus

(76) Inventor: Jim Gammon, Troy, MI (US)

Correspondence Address: MYERS BIGEL SIBLEY & SAJOVEC, PO BOX 37428, RALEIGH, NC, 27627, US

(21) Appl. No.: 10/615,096

(22) Filed: Jul. 8, 2003

Related U.S. Application Data
(60) Provisional application No. 60/439,732, filed on Jan. 13, 2003.

(51) Int. Cl. B60R 7/00; B60R 9/00; B60R 11/00

(52) U.S. Cl. 224/275; 224/542

(57) ABSTRACT

A collapsible cargo storage apparatus that is configured to be positioned on a rear seat of a vehicle includes a pair of adjacent base panels that are pivotably connected together and that are movable between operative positions and stored positions. Each base panel has respective opposite upper and lower surfaces, opposite front and rear portions, and a side portion. The lower surface of each base panel has a contour that is configured to matingly engage the contour of a respective seating area. A rear panel, front panel and end panel may be pivotally attached to each base panel that are movable between a closed and open positions.

### RELATED APPLICATION

This application claims the benefit of U.S. Provisional Application No. 60/439,732 filed Jan. 13, 2003, the disclosure of which is incorporated herein by reference in its entirety as if set forth fully herein.

### FIELD OF THE INVENTION

The present invention relates generally to vehicles and, more particularly, to cargo management apparatus for use within vehicles.

### BACKGROUND OF THE INVENTION

Motor vehicles are typically provided with a cargo storage compartment of some type. For example, sedan-style automobiles are conventionally equipped with a trunk. Sport/utility and mini-van vehicles, in which there are two or more rows of seating, are conventionally provided with a cargo storage area behind the last row of seating. In addition, vehicle seats are sometimes used to transport cargo.

Items carried within vehicle cargo storage areas, including items placed on vehicle seats, are often free to move about during vehicle operation, which may be undesirable. Cargo netting may be used to restrain items from movement within vehicle cargo storage compartments. While such netting may adequately restrain items from movement, cargo netting may require the use of two hands to hold the cargo netting back while placing items therewithin, which may be cumbersome.

Various devices are known for dividing vehicle storage compartments to prevent movement of items stored therein. For example, U.S. Pat. No. 6,027,155 to Wisniewski et al. describes a storage system for a vehicle cargo compartment that includes a cover that is removably attached to the floor of the cargo compartment and that is configured to rotate between open and closed positions. U.S. Pat. No. 5,669,537 to Saleem et al. describes a storage unit that extends between, and connects to, vehicle panels of a vehicle storage area. U.S. Pat. No. 5,501,384 to Wisniewski describes a storage system for a vehicle that includes a molded bin and a cover pivotally secured to the bin.

Unfortunately, these devices are somewhat complex and bulky and are not adapted to be compactly stored within the cargo storage area of a vehicle. Moreover, in automotive vehicles such as sport/utility vehicles and mini-vans, cargo storage space may be somewhat limited. Accordingly, a need exists for a cargo storage device that can securely retain items within a cargo storage area during operation of a vehicle and that can be easily stored in an out-of-the-way location when not needed, and without requiring that the storage device be removed from the cargo storage area. In addition, a need exists to maximize the efficiency and utilization of existing cargo storage space.

### SUMMARY OF THE INVENTION

In view of the above discussion, a collapsible cargo storage apparatus that is configured to be positioned on a seat of a vehicle and to receive items therein for storage is provided. According to embodiments of the present invention, the storage apparatus includes a pair of adjacent base panels that are pivotably connected together and that are movable between operative positions and stored positions. The base panels are substantially co-planar when in respective operative positions and are in adjacent, face-to-face relationship when in respective stored positions. Each base panel has respective opposite upper and lower surfaces, opposite front and rear portions, and a side portion. The lower surface of each base panel may have a contour that is configured to matingly engage the contour of a respective seating area.

According to embodiments of the present invention, the storage apparatus includes a pair of rear panels, each pivotally attached to a respective base panel and having opposite front and rear sides. Each rear panel is movable between a closed position wherein the front side thereof is in overlying, face-to-face relation with the base upper surface and an open position wherein the rear panel is disposed substantially normal to the base upper surface. The storage apparatus also includes a pair of front panels, each pivotally attached to a respective base panel and having opposite front and rear sides. Each front panel is movable between a closed position wherein the front side thereof is in overlying, face-to-face relation with the base upper surface and an open position wherein the front panel is disposed substantially normal to the base upper surface. According to embodiments of the present invention, each rear panel may have a contour or shape that is configured to matingly engage the contour of the back portion of a vehicle seat.

In an open position, each base panel and respective front and rear panel define a respective storage compartment for receiving items therein. In a stored position, the storage apparatus can easily be stored out of the way.

According to embodiments of the present invention, the storage apparatus also may include a pair of end panels, each pivotally attached to a respective base panel side portion and having opposite front and rear sides. Each end panel is movable between a closed position wherein the front side is in overlying, face-to-face relation with the base upper surface and an open position wherein the end panel is disposed substantially normal to the base upper surface.

Storage apparatus according to embodiments of the present invention can be advantageous because they can be lightweight, easy to store and easy to set up and use. In addition, storage apparatus according to embodiments of the present invention may have a color, style, decor that matches that of a vehicle. In addition, storage apparatus according to embodiments of the present invention may be designed to fit within a particular vehicle seat such that the storage apparatus does not move around during vehicle movement.

### BRIEF DESCRIPTION OF THE DRAWINGS

The accompanying drawings, which form a part of the specification, illustrate key embodiments of the present invention. The drawings and description together serve to fully explain the invention.

FIG. 1 is a perspective view of a vehicle seat cargo storage apparatus, according to embodiments of the present invention.

FIG. 2 is a perspective view of the storage apparatus of FIG. 1 in a collapsed, stored configuration.

FIGS. 3-4 illustrate opening the storage apparatus of FIG. 1 from the stored configuration illustrated in FIG. 2.

FIG. 5 is a perspective view of the storage apparatus of FIG. 1 positioned on the rear seat of a vehicle.

FIG. 6 is a perspective view of a vehicle seat cargo storage apparatus, according to other embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the drawings, the thickness of lines, layers and regions may be exaggerated for clarity. It will be understood that when an element such as a layer, region, substrate, or panel is referred to as being “on” another element, it can be directly on the other element or intervening elements may also be present. In contrast, when an element is referred to as being “directly on” another element, there are no intervening elements present.

It will be understood that when an element such as a layer, region, substrate, or panel is referred to as being “adjacent” or “overlying” another element, it can be directly adjacent or overlying the other element or intervening elements may also be present.

It will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “vertical”, “horizontal” and the like are used herein for the purpose of explanation only.

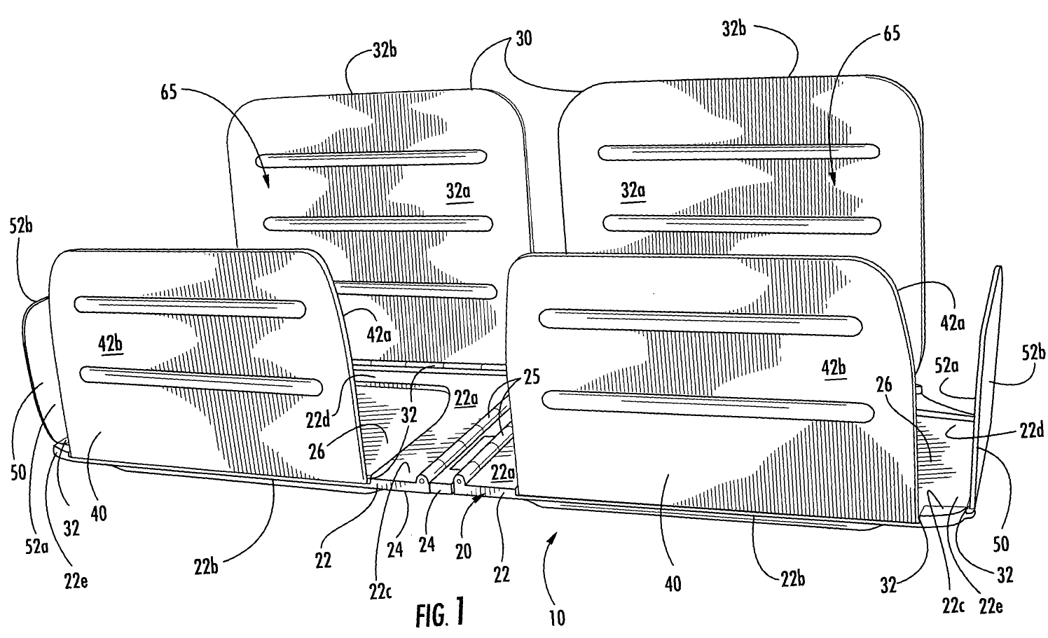

Referring to FIG. 1, a storage apparatus 10 that is configured to be positioned on a seat of a vehicle and to receive items therein for storage, according to embodiments of the present invention, is illustrated. The illustrated storage apparatus 10 includes a generally rectangular base 20 that is configured to be supported by adjacent seating areas of a vehicle seat. The illustrated base 20 includes a pair of adjacent base panels 22 that are pivotably connected together via an intermediate portion 24. The illustrated base panels 22 are pivotably connected to the intermediate portion 24 via respective hinges 25 and are movable between operative positions and stored positions. The base panels 22 are substantially co-planar when in respective operative positions and are in spaced-apart adjacent, face-to-face relationship when in respective stored positions.

Each base panel 22 has respective opposite upper and lower surfaces 22a, 22b, opposite front and rear portions 22c, 22d, and a side portion 22e. The upper surface 22a of each base panel 22 is at least partially exposed when the storage apparatus 10 is in an operative (i.e., open) position. The illustrated lower surface 22b of each base panel 22 has a contour that is configured to matingly engage the contour of a respective seating area. This contour helps retain the storage apparatus 10 on the seat and reduces the likelihood of the storage apparatus moving during vehicle movement. In addition, the contour of the lower surface 22b may be such that the upper surface 22a is retained in a generally horizontal orientation.

Embodiments of the present invention do not require that the lower surface 22b of each base panel 22 have a contour that is configured to matingly engage with a seat portion. In addition, although the illustrated base panels 22 have a generally rectangular configuration, base panels having any size and shape (e.g., circular, oval, square, etc.) may be utilized in accordance with embodiments of the present invention.

The illustrated storage apparatus 10 includes a pair of rear panels 30, each pivotally attached to a respective base panel rear portion 22d via one or more hinges 32. Each rear panel 30 has opposite front and rear sides 32a, 32b and is movable between a closed position wherein the front side 32a is in overlying, face-to-face relation with the base upper surface 22a and an open position wherein the rear panel 30 is disposed substantially normal to the base upper surface 22a. The illustrated rear panels 30 are substantially co-planar when both are in respective open positions and when both are in respective closed positions. According to embodiments of the present invention, each rear panel 30 may have a contour (or the rear side 32b thereof may have a contour) that is configured to matingly engage the contour of a respective seat back.

The illustrated apparatus 10 includes a pair of front panels 40, each pivotally attached to a respective base panel front portion 22c via one or more hinges 32. Each front panel 40 has opposite front and rear sides 42a, 42b and is movable between a closed position wherein the front side 42a is in overlying, face-to-face relation with the base upper surface 22a and an open position wherein the front panel 40 is disposed substantially normal to the base upper surface 22a. The illustrated front panels 40 are substantially co-planar when both are in respective open positions and when both are in respective closed positions.

The illustrated apparatus 10 also includes a pair of end panels 50, each pivotally attached to a respective base panel side portion 22e via one or more hinges 32 and having opposite front and rear sides 52a, 52b. Each end panel 50 is movable between a closed position wherein the front side 52a is in overlying, face-to-face relation with the base upper surface 22a and an open position wherein the end panel 50 is disposed substantially normal to the base upper surface 22a.

In an open position, each base panel 22 and respective rear panel 30, front panel 40, end panel 50 define a respective storage compartment 65 for receiving items therein. Hinges 25, 32 may be of virtually any type known to those skilled in the art. In addition, a spring or other biasing member may be utilized to urge the various panels 22, 30, 40, 50 to open and/or closed positions as would be understood by those skilled in the art.

According to embodiments of the present invention, the base, rear, front, and end panels 22, 30, 40, 50 may be configured to snap into a locked orientation such that they remain firmly in an open configuration until it is desired to close the apparatus 10 for storage. In addition, or alternatively, the base, rear, front, and end panels 22, 30, 40, 50 may be configured to snap into a locked orientation such that they remain firmly in a stored configuration until it is desired to open the apparatus 10 for use. The base, rear, front, and end panels 22, 30, 40, 50 may have various shapes sizes and configurations and are not limited to the illustrated embodiments.

In the illustrated embodiment, a recessed portion 26 is formed in each base panel upper surface 22a. Each recessed portion 26 is configured to receive a respective end panel 50 and front panel 40 therein when moved to stored positions. Accordingly, the storage apparatus 10 can achieve a more compact stored configuration. However, embodiments of the present invention do not require a recess in the base panel upper surface 22a. Moreover, the various panels 30, 40, 50 may be overlap each other in various configurations and orders when in respective stored positions, according to embodiments of the present invention.

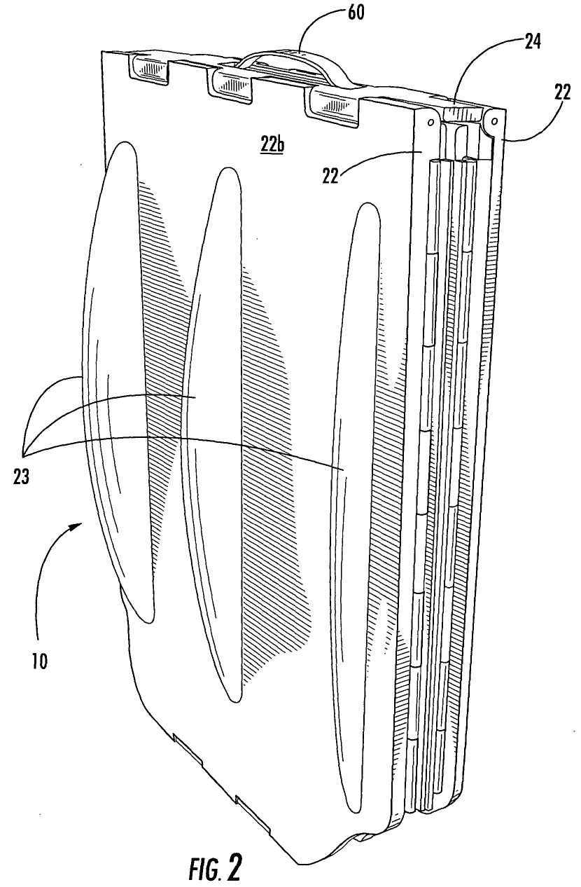

FIG. 2 illustrates the storage apparatus 10 of FIG. 1 in a collapsed, stored configuration wherein the respective base panels 22 are in adjacent face-to-face relationship and wherein the panels 30, 40, 50 are in overlying face-to-face relationship with a respective base panel 22. In the illustrated embodiment, a handle 60 is connected to the intermediate portion 24 which allows a user to easily carry the storage apparatus 10 when the storage apparatus 10 is in a stored configuration. Handles having various shapes, configurations and locations may be utilized in accordance with embodiments of the present invention. Embodiments of the present invention are not limited to the illustrated handle 60. It is to be understood that embodiments of the present invention do not require a handle (i.e., handles are optional).

As shown in FIG. 2, the illustrated embodiment of each base panel lower surface 22b includes a plurality of ribs 23. of differing sizes and shapes. These ribs 23 provide each respective base panel 22 with contour that matingly engages a respective seating area of a vehicle seat. The ribs 23 are configured to help maintain the storage apparatus 10 in a seat and to help prevent movement of the storage apparatus 10 during vehicle movement. In addition, the ribs 23 may have a configuration that allows the each base panel upper surface 22a to be substantially horizontal when the storage apparatus is installed on a vehicle seat. For example, the ribs 23 may have a tapered configuration that counters a sloped configuration of a vehicle seat, as would be understood by those skilled in the art.

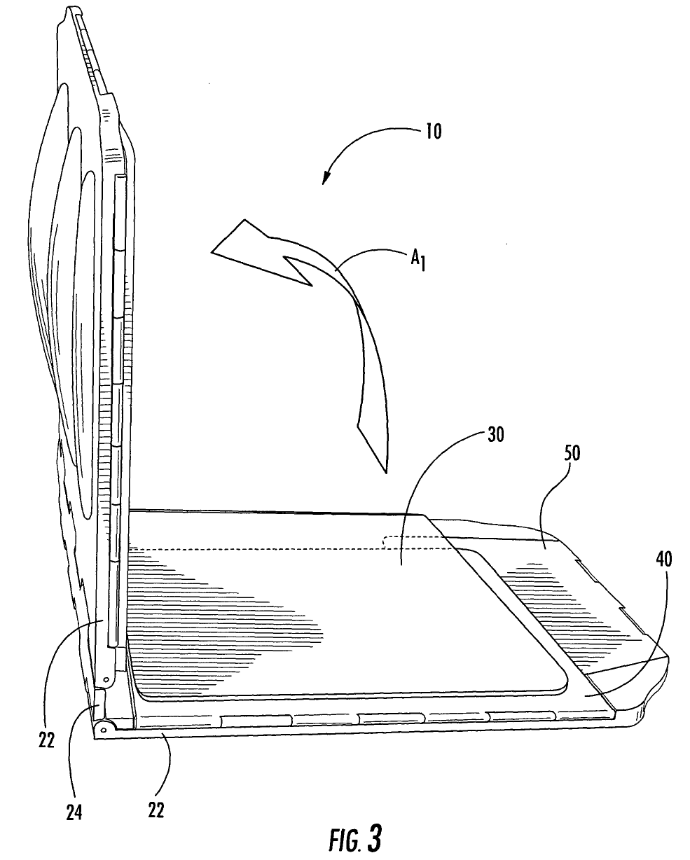

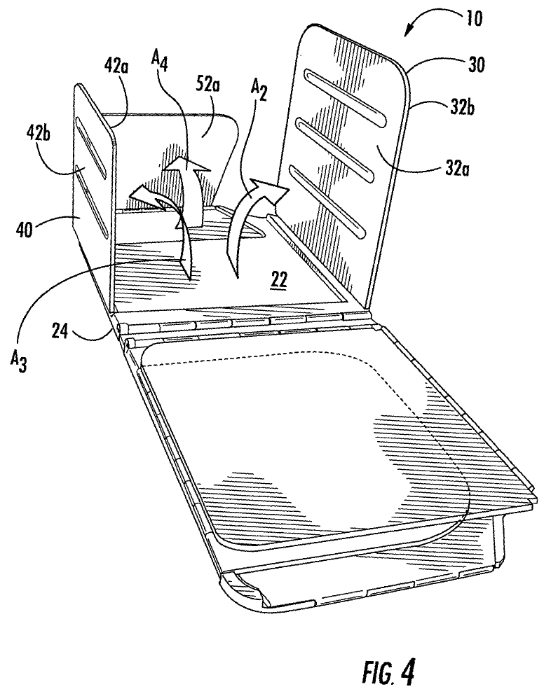

FIGS. 3-4 illustrate steps for opening the storage apparatus 10 of FIG. 1 from the stored configuration illustrated in FIG. 2. In FIG. 3, the respective base panels 22 are being pivoted relative to one another to respective open positions as indicated by arrow A1. In FIG. 4, the panels 30, 40, 50 of a respective base panel 22 have been moved to respective open positions as indicated by arrows A₂, A₃, A₄

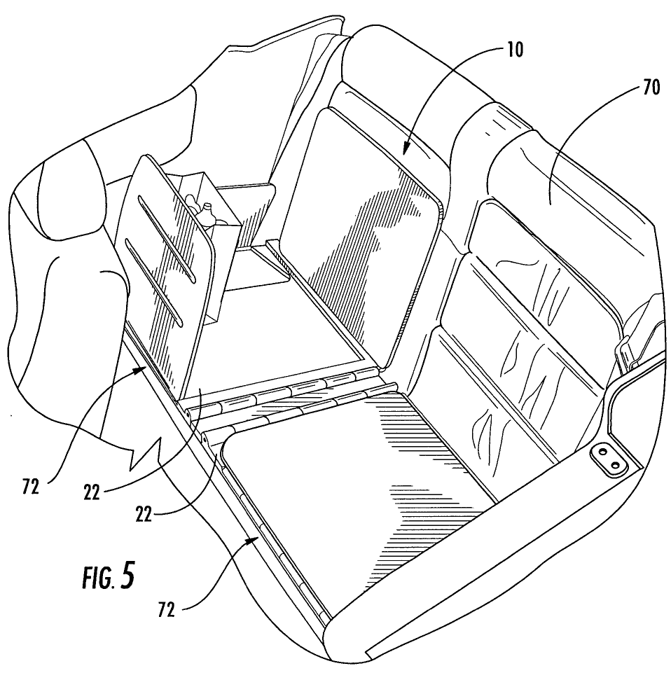

FIG. 5 illustrates the apparatus 10 of FIGS. 1-4 positioned on the rear seat 70 of a vehicle. As illustrated, each base panel 22 is positioned within a respective seating area 72 of the seat 70.

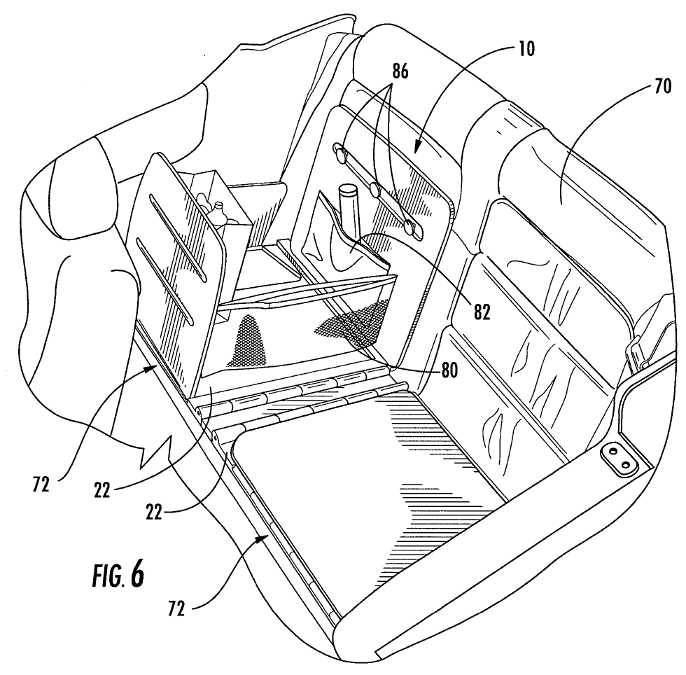

FIG. 6 illustrates a storage apparatus 110 according to other embodiments of the present invention. The illustrated apparatus 110 includes cargo netting 80 and one or more storage pockets 82. The illustrated apparatus 110 also includes projections 86 (e.g., hooks) that extend from the rear panels 30 and that are configured to support articles suspended therefrom, such as loaded grocery bags, and the like.

The storage apparatus 10 may be formed of various types of materials, without limitation. According to embodiments of the present invention, the various panels are formed from light-weight, durable polymeric materials.

Storage apparatus according to embodiments of the present invention may have colors and decor that match that of a vehicle interior.

Storage apparatus according to embodiments of the present invention may be designed for virtually any type of vehicle seat, whether a single vehicle seat or multiple vehicle seats. Moreover, storage apparatus according to embodiments of the present invention may be designed for virtually any type of vehicle.

Embodiments of the present invention are not limited to vehicle seats having two seating areas. A storage apparatus, a storage apparatus according to embodiments of the present invention, may be configured for a single seating area of a vehicle seat. Moreover, a storage apparatus according to embodiments of the present invention, may be configured for a vehicle seat having three or more adjacent seating areas.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention.

That which is claimed is:

1. A collapsible cargo storage apparatus for a vehicle interior having a seat, the cargo management system comprising:
a base configured to be supported by the seat, wherein the base comprises opposite upper and lower surfaces, opposite front and rear portions, and opposite side portions, and wherein the base lower surface has a contour that matingly engages a contour of the seat;
a front panel pivotably attached to the base front portion via a hinge; and
a rear panel pivotably attached to the base rear portion via a hinge;
wherein the front and rear panels are each movable between a stored position and an operative position, wherein the front and rear panels extend generally perpendicular to the base for constraining motion of articles disposed on the base upper surface when in the operative position, and wherein the front and rear panels overlie the base upper surface in a flat configuration when in the stored position.

2. The storage apparatus of claim 1, further comprising a pair of end panels pivotably attached to the respective base end portions, wherein each end panel is movable between a stored position and an operative position, wherein the end panels extend generally perpendicular to the base for constraining motion of articles disposed on the base upper surface when in the operative position, and wherein the end panels overlie the base upper surface in a flat configuration when in the stored position

3. The storage apparatus of claim 1, wherein the base lower surface contour matingly engages a contour of a seat such that the base upper surface is maintained in a generally horizontal orientation when the storage apparatus is installed within a vehicle.

4. The storage apparatus of claim 1, wherein the rear panel has a contour that is configured to matingly engage a contour of a vehicle seat back when the storage apparatus is installed within a vehicle.

5. The storage apparatus of claim 1, wherein the front and rear panels are pivotably attached to the base panel via respective hinges, and wherein the hinges are configured to bias the front and rear panels to respective operative positions.

6. The storage apparatus of claim 2, wherein the front and rear panels are pivotably attached to the base panel via respective hinges, and wherein the hinges are configured to bias the front and rear panels to respective stored positions.

7. The storage apparatus of claim 1, wherein the front panel has a first height, wherein the rear panel has a second height different from the first height.

8. The storage apparatus of claim 1, wherein one or more of the front, rear and end panels comprises a storage pocket for receiving articles therein.

9. The storage apparatus of claim 1, wherein one or more of the front, rear and end panels comprises at least one projection extending therefrom that is configured to support one or more loaded shopping bags by the handles thereof and to maintain the one or more loaded shopping bags in an upright position during operation of the vehicle.

10. The storage apparatus of claim 1, further comprising a handle that facilitates carrying the apparatus when the front, rear and end panels are in respective stored positions.

11. A collapsible cargo storage apparatus for a vehicle interior having a rear seat, wherein the rear seat includes two adjacent seating areas, the cargo management system comprising:
a base configured to be supported by the rear seat, wherein the base comprises a pair of adjacent, substantially co-planar base panels separated by an intermediate portion, each base panel comprising opposite upper and lower surfaces, opposite front and rear portions, and a side portion, wherein the lower surface of each base panel has a contour that matingly engages a contour of a respective one of the seating areas, and wherein the base is configured to fold along the intermediate portion thereof such that the base panels are in adjacent, face-to-face relationship to facilitated storage;
a front panel pivotably attached to the front portion of each base panel; and
a rear panel pivotably attached to the rear portion of each base panel;
wherein the front and rear panels for each base panel are each movable between a stored position and an operative position, wherein the front and rear panels extend generally perpendicular to the respective base panel for constraining motion of articles disposed on the base panel upper surface when in the operative position, and wherein the front and rear panels overlie the respective base panel upper surface in a flat configuration when in the stored position.

12. The storage apparatus of claim 11, further comprising an end panel pivotably attached to a respective base panel side portion, wherein each end panel is movable between a stored position and an operative position, wherein each end panel extends generally perpendicular to a respective base panel for constraining motion of articles disposed on the respective base panel upper surface when in the operative position, and wherein each end panel overlies the respective base panel upper surface in a flat configuration when in the stored position.

13. The storage apparatus of claim 11, wherein the base lower surface contour matingly engages a contour of a seat such that the base upper surface is maintained in a generally horizontal orientation when the storage apparatus is installed within a vehicle.

14. The storage apparatus of claim 11, wherein the rear panel has a contour that is configured to matingly engage a contour of a vehicle seat back when the storage apparatus is installed within a vehicle.

15. The storage apparatus of claim 11, wherein the respective front and rear panels are pivotably attached to the base panel via respective hinges, and wherein the hinges are configured to bias the respective front and rear panels to respective operative positions.

16. The storage apparatus of claim 11, wherein the respective front and rear panels are pivotably attached to the base panel via respective hinges, and wherein the hinges are configured to bias the respective front and rear panels to respective stored positions.

17. The storage apparatus of claim 11, wherein each front panel has a first height, wherein each rear panel has a second height different from the first height.

18. The storage apparatus of claim 11, wherein one or more of the front, rear and end panels comprises a storage pocket for receiving articles therein.

19. The storage apparatus of claim 11, wherein one or more of the front, rear and end panels comprises at least one projection extending therefrom that is configured to support one or more loaded shopping bags by the handles thereof and to maintain the one or more loaded shopping bags in an upright position during operation of the vehicle.

20. The storage apparatus of claim 11, further comprising a handle attached to the base intermediate portion.

21. The storage apparatus of claim 11, wherein one or more of the front, rear and end panels comprises cargo netting for restraining articles placed within the storage apparatus.
